(19) United States
(12) Patent Application Publication
(10) Pub. No.: US 2006/0059560 A1
(43) Pub. Date: Mar. 16, 2006

(54) Systems and methods for detecting music sharing

(76) Inventor: Louis J. Montulli, Reno, NV (US)

Correspondence Address: TRAN & ASSOCIATES, 6768 MEADOW VISTA CT., SAN JOSE, CA, 95135, US

(21) Appl. No.: 10/938,450

(22) Filed: Sep. 10, 2004

(51) Int. Cl. H04N 7/16

(52) U.S. Cl. 726/26

(57) ABSTRACT

Systems and methods are disclosed to distribute music by embedding ownership information in a music file; detecting unauthorized sharing of the music file; and determining an owner of the shared music file by decoding the embedded ownership information from the music file.

### COPYRIGHT RIGHTS

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

This invention relates to digital music distribution.

Music players of widely varying type are ubiquitous throughout the world, and have evolved through various forms over the years, from portable single transistor radios in the 1950's to tape cassette players to compact disc players and more recently to MP3 players, which enable a user to download audio material from an internet site and store same in storage medium of a player in an MP3 (MPEG-1 audio layer 3) format for subsequent selective listening.

Enhancements to the basic MP3 players have since appeared. For example, U.S. Pat. No. 6,591,085 discloses an FM transmitter and power supply/charging assembly electrically that can be added to an MP3 player. The assembly includes a modular docking unit having a main body portion with a docking cavity therein, wherein the main body portion contains the FM transmitter and power/charging circuitry, with coupling means in the docking cavity for connecting the MP3 player with the FM transmitter and power/charging circuitry, to accommodate FM transmission by the FM transmitter of audio content when played by the MP3 player in the docking cavity of the modular docking unit, and adapted for transmitting electrical power through the modular docking unit and the power/charging circuitry therein, for charging of a battery of the MP3 player and/or powering of the MP3 player.

Additionally, network music playing devices also appeared. For example, a network music player from Slim Devices (SLIMP3) called Squeezebox receives music streamed from a user's computer over a wireless or wired network. Once installed and configured, Squeezebox enables the user to access to songs in the user's digital music collection, anywhere in his or her home.

One issue that the music players need to address is that musical compositions and sound recordings are creative works that are protected by the copyright laws of the United States (title 17, U.S. Code) and other countries. Under U.S. law, the owner of a copyright has the exclusive right to (and to authorize others to) reproduce the work, use parts of the work in a new creation, distribute the work in whole or in part, and to publicly display or perform the work (including on web pages and through webcasting). With few exceptions, it is illegal to reproduce, distribute or broadcast a sound recording without the permission of the copyright owner.

There have been recent amendments to the copyright law regarding webcasting of sound recordings. These new provisions allow webcasting under the terms of a statutory license, as a way to help webcasters get permission without having to go to each sound recording's owner. The statutory license, however, has strict requirements that the user must follow. Some of these requirements include the payment of license fees and limitations called the sound recording performance complement, among others.

### SUMMARY

Systems and methods are disclosed to distribute music by embedding ownership information in a music file; detecting unauthorized sharing of the music file; and determining an owner of the shared music file by decoding the embedded ownership information from the music file.

In another aspect, a system to support secure music distribution includes a communication network in a facility; a server coupled to the network, the server adapted to store one or more music files encoded with ownership information; a player coupled to the network, the player adapted to play the music files; and a copyright protection device coupled to the server, the device detecting unauthorized sharing of the music file and determining an owner of the shared music file by decoding the embedded ownership information from the music file.

Advantages of the system may include one or more of the following. The watermarking can be used in protecting intellectual property rights, e.g., through copy control, automatic broadcast monitoring, ownership dispute resolution, Internet commerce tracking, etc. Alternative applications include auxiliary data embedding, such as the song title and purchasing instructions, assurance of content integrity, proof of performance in TV and radio advertisements, audience exposure monitoring, caller identification (authentication) in telephone conversations, or generic covert communication.

Other aspects of the present invention are described in the following detailed description of the invention, in the claims and in the accompanying drawings.

### BRIEF DESCRIPTION OF THE DRAWINGS

FIG. 1 shows an environment for distributing and playing music.

FIG. 2 shows one embodiment of a process for securely distributing music.

FIG. 3 shows a diagram of an exemplary process for purchasing music.

FIG. 4 shows one embodiment of an exemplary process to play secured music.

FIG. 5 shows one embodiment of a simplified flow diagram of a process for buying and distributing secured music.

### DESCRIPTION

Referring now to the drawings in greater detail, there is illustrated therein structure diagrams for an online music transaction system and logic flow diagrams for the processes a computer system will utilize to complete various music distribution transactions. It will be understood that the program is run on a computer that is capable of communication with consumers via a network, as will be more readily understood from a study of the diagrams.

FIG. 1 shows an environment for distributing and playing music. A master music server 20 is connected to a network 10 such as the Internet. One or more facilities 30 are also connected to the network 102. Each facility 30 has a local music server 32 that communicates over a local area network with one or more players 34-36 that are distributed over the facility. The facility can be a user's home or office, for example. The local area network can be wired or wireless. Moreover, the wireless network can interoperate with any suitable wireless protocol such as 802.11X or Bluetooth, among others.

The players 34-36 can be an embedded computer or can be personal computers or workstations running browsers such as Netscape or Internet Explorer. With the browser, a client or user can access the server 20's Web site by clicking in the browser's Address box, and typing the address (for example, www.seascape.com), then press Enter. When the page has finished loading, the status bar at the bottom of the window is updated. The browser also provides various buttons that allow the client or user to traverse the Internet or to perform other browsing functions.

An Internet community 11 with one or more service providers or marketers may be connected to the network 10 and can communicate directly with facilities 30 or indirectly through the server 20. The Internet community 11 provides the consumers with access to a network of music specialists that can enhance the listening experience such as network audio specialists, installers, and content generators, among others.

Although the server 20 can be an individual server, the server 20 can also be a cluster of redundant servers. Such a cluster can provide automatic data failover, protecting against both hardware and software faults. In this environment, a plurality of servers provides resources independent of each other until one of the servers fails. Each server can continuously monitor other servers. When one of the servers is unable to respond, the failover process begins. The surviving server acquires the shared drives and volumes of the failed server and mounts the volumes contained on the shared drives. Applications that use the shared drives can also be started on the surviving server after the failover. As soon as the failed server is booted up and the communication between servers indicates that the server is ready to own its shared drives, the servers automatically start the recovery process. Additionally, a server farm can be used. Network requests and server load conditions can be tracked in real time by the server farm controller, and the request can be distributed across the farm of servers to optimize responsiveness and system capacity. When necessary, the farm can automatically and transparently place additional server capacity in service as traffic load increases.

The server 20 can also be protected by a firewall. When the firewall receives a network packet from the network 10, it determines whether the transmission is authorized. If so, the firewall examines the header within the packet to determine what encryption algorithm was used to encrypt the packet. Using this algorithm and a secret key, the firewall decrypts the data and addresses of the source and destination firewalls and sends the data to the server 20. If both the source and destination are firewalls, the only addresses visible (i.e., unencrypted) on the network are those of the firewall. The addresses of computers on the internal networks, and, hence, the internal network topology, are hidden. This is called “virtual private networking” (VPN).

The server 20 supports a music portal that provides a single point of integration, access, and navigation through the multiple enterprise systems and information sources available to music buyers. The server 20 allows a consumer to log onto a computerized music purchasing system over a network and automates the operations required to personalize a copy of the music to a particular purchaser. Using the server 20, the following primary activities can be done:
1) Searching: A buyer would be able to use specific criteria and parameters to rapidly search through a large database of available suppliers. Users could alternatively call an 800 number and use a helpdesk to obtain a set of supplier that best meet their needs.
2) Purchasing: A buyer can pay through bank withdrawals, PayPal, or credit card and after receipt of payment, the system personalizes a copy of the music file to the buyer's identification so that the music content is available only to each paying customer.
5) Support: Buyers and suppliers get several support services and document templates during the whole process. The system provides these services, of which, some are basic and some are value added.

In addition, information relating to the various portions of a transaction are captured and stored in a single convenient location where it can be accessed at any time. Thus, the user can authenticate his music for playing on-demand at any location and at any time.

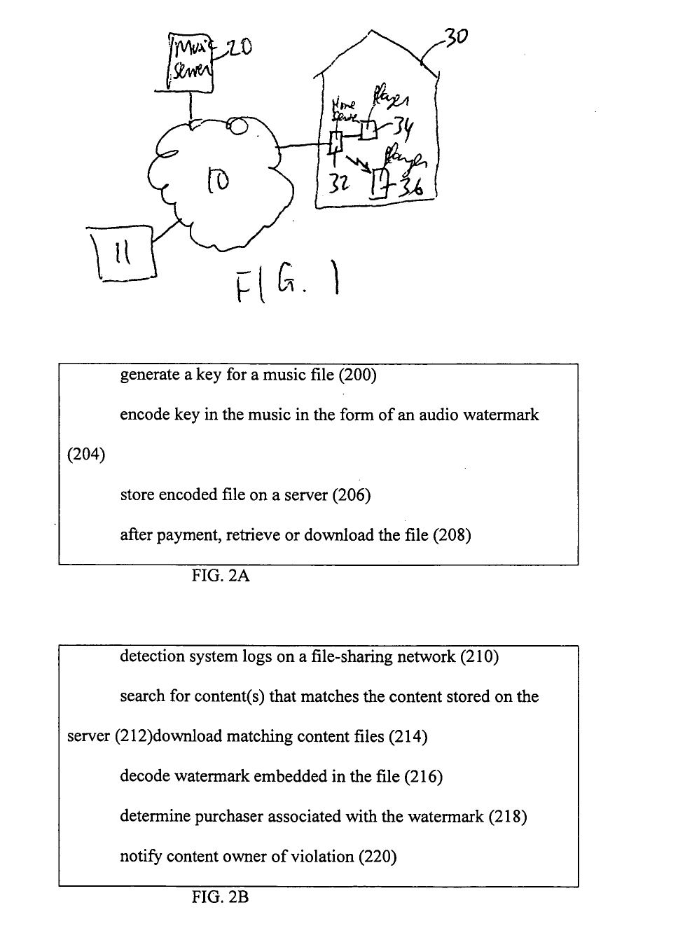

FIG. 2A shows one embodiment of a process for securely distributing music. First, the process generates a key for a music file (200). Next, the process encodes the key in the music in the form of an audio watermark (204). Audio watermarking, or embedded signaling, has recently emerged as a technology for embedding auxiliary data imperceptibly in a host audio signal. A basic feature of audio watermarking techniques is that the embedded signal is substantially imperceptible to a listener of the host signal. Furthermore, the audio-watermarks occupy the same time/frequency/space domain as the host signal, so that they are not lost in standard audio signal processing, recording or transmissions. Further, filtering and/or masking operations in a deliberate attack cannot remove the watermarks. The encoded file is stored on a server (206). The user locates the file for purchase and after payment, the user can retrieve or download the file (208).

In one embodiment, the file can be freely played, and the watermarking is only used to identify the purchaser should the file be later uploaded to a file-sharing network. In another embodiment, the player decodes the presence of the watermark for authentication prior to playing the music.

FIG. 2B shows an exemplary embodiment for detecting unauthorized distribution. First, a detection system logs on a file-sharing network (210). The system searches for content(s) that matches the content stored on the server (212). Each matching content file is downloaded (214), and the watermark embedded in the file is decoded (216). The purchaser associated with the watermark is determined through a database look-up (218) and the publisher of the content file is notified (220). Alternatively, the detection system can send a warning to the purchaser or report the purchaser to a content protection organization, among others.

Various audio watermarking techniques can be used. For example, it is known to pulse-width modulate a signal to provide a common or encoded signal carrying at least two information portions or other useful portions. In U.S. Pat. No. 4,497,060 to Yang (1985) binary data is transmitted as a signal having two differing pulse-widths to represent logical “0” and “1” (e.g., the pulse-width durations for a “1” are twice the duration for a “0”). This correspondence also enables the determination of a clocking signal. U.S. Pat. No. 4,937,807 to Weitz et al. (1990) discloses a method and apparatus for encoding signals for producing sound transmissions with digital information to enable addressing the stored representation of such signals. Specifically, the apparatus in Weitz et al. converts an analog signal for producing such sound transmissions to clocked digital signals comprising for each channel an audio data stream, a step-size stream and an emphasis stream. With respect to systems in which audio signals produce audio transmissions, U.S. Pat. No. 4,876,617 to Best et al. (1989) and U.S. Pat. No. 5,113,437 to Best et al. (1992) disclose encoders for forming relatively thin and shallow (e.g., 150 Hz wide and 50 dB deep) notches in mid-range frequencies of an audio signal. The earlier of these patents discloses paired notch filters centered about the 2883 Hz and 3417 Hz frequencies; the later patent discloses notch filters but with randomly varying frequency pairs to discourage erasure or inhibit filtering of the information added to the notches. The encoders then add digital information in the form of signals in the lower frequency indicating a “0” and in the higher frequency a “1”. In the later Best et al. patent an encoder samples the audio signal, delays the signal while calculating the signal level, and determines during the delay whether or not to add the data signal and, if so, at what signal level. The later Best et al. patent also notes that the “pseudo-random manner” in moving the notches makes the data signals more difficult to detect audibly. Other prior art techniques employ the psychoacoustic model of the human perception characteristic to insert modulated or unmodulated tones into a host signal such that they will be masked by existing signal components and thus not perceived. See. e.g. Preuss et al., U.S. Pat. No. 5,319,735, and Jensen et al., U.S. Pat. No. 5,450,490. Such techniques are very expensive and complicated to implement, while suffering from a lack of robustness in the face of signal distortions imposed by perception-based compression schemes designed to eliminate masked signal components.

The audio watermarking can also be the technique disclosed in Petrovic, et al., U.S. Pat. No. 5,940,135 where the autocorrelation function of a host signal is modulated according to the value of an auxiliary information signal by adding a host modifying signal to the host signal. The auxiliary signal is decoded by generating the autocorrelation function of the encoded signal and extracting the auxiliary signal according to well-known signal extraction techniques.

Other watermarking techniques can be used as well. For example, the watermarking may also be obtained under some circumstances using transform-domain processing techniques (such as Fourier or cepstral domain) which may be implemented using known algorithms such as the Fast Fourier Transform or FFT.

In one embodiment, after the user gets the file no further decoding of the watermark is done. Players do not look for the watermark and simply play the file without detecting existence of the watermark. In this embodiment, the watermarked file is only detected when they are uploaded to a file-sharing network.

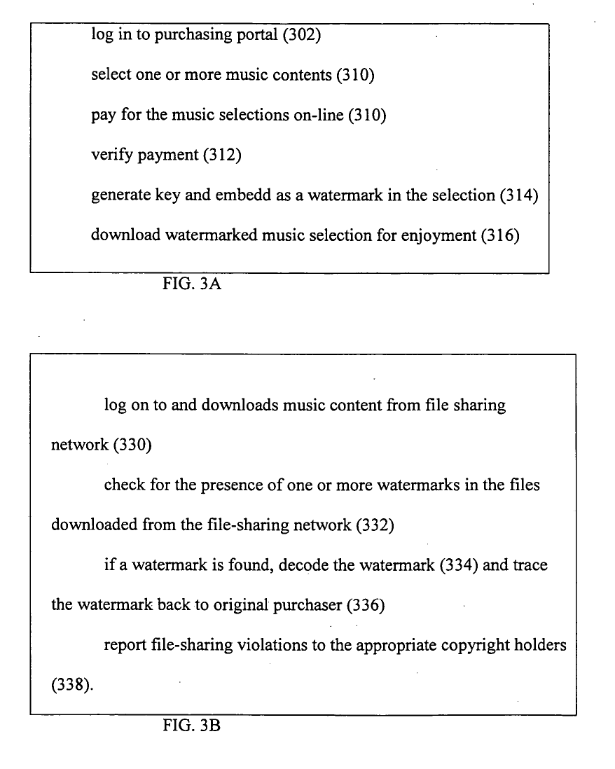

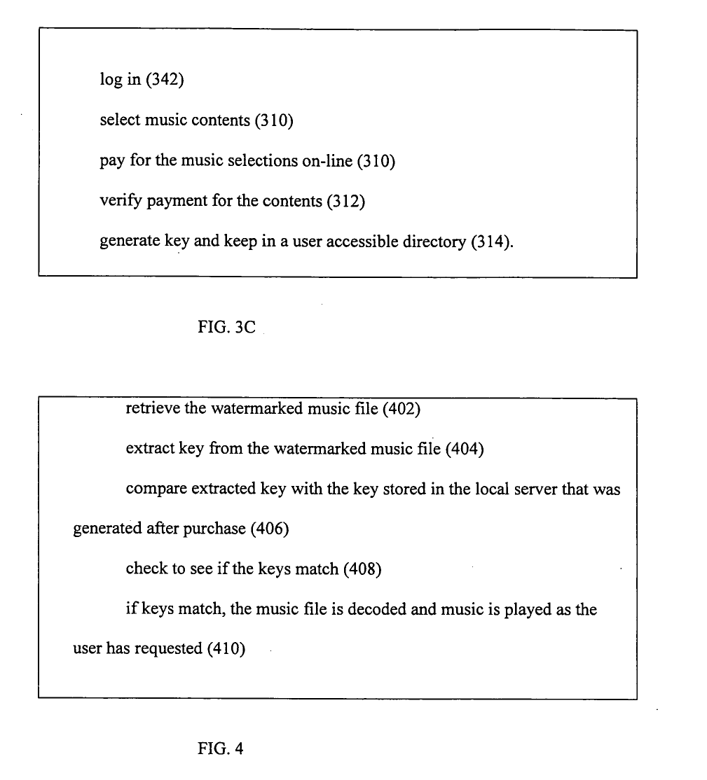

FIG. 3A shows a diagram of a second embodiment for purchasing music. First, the user logs in (302). The user then selects one or more music contents (310). In one embodiment, the items are placed in a shopping cart. After the user is done with browsing the music selections, the user can pay for the music selections on-line (310). The payment for the contents is verified (312), and a key is generated and is embedded as a watermark in the selection (314). The watermarked music selection can be downloaded by the buyer for enjoyment (316).

In one embodiment, the sole purpose of the watermarked music content is to deter the music content from being used with a file-sharing network or service. FIG. 3B shows an exemplary embodiment for enforcing copyright restrictions associated with a particular content. First, the process logs on to and downloads music content from file sharing networks such as Kazaa (330). The process then checks for the presence of one or more watermarks in the files downloaded from the file-sharing network (332). If a watermark is found, the process decodes the watermark (334) and traces the watermark back to the original purchaser (336). The process then reports file-sharing violations to the appropriate copyright holders (338). The copyright holders can then contact the purchaser or take actions as appropriate to keep the files downloaded from the server 20 from being illegally posted to the file sharing networks. In addition to the copyright holders, copyright representatives can be contacted as well. Exemplary copyright representatives include the Recording Industry Association of America, ASCAP and BMI, among others.

FIG. 3C shows a diagram of an exemplary process for purchasing music. First, the user logs in (342). The user then selects one or more music contents (310). In one embodiment, the items are placed in a shopping cart. After the user is done with browsing the music selections, the user can pay for the music selections on-line (310). The payment for the contents is verified (312), and a key is generated and kept in a user accessible directory (314). In one embodiment, the key is kept at the local server so that the user can authenticate once for the secured music to be played in any room of the house.

FIG. 4 shows one embodiment of an exemplary process to play secured music. First, the process retrieves the watermarked music file (402). Next, the key is extracted from the watermarked music file (404). The process then compares the extracted key with the key stored in the local server that was generated after a purchase (406). Next the process checks to see if the keys match (408). If so, the music file is decoded and music is played as the user has requested (410). Alternatively, if the authentication fails, the process exits.

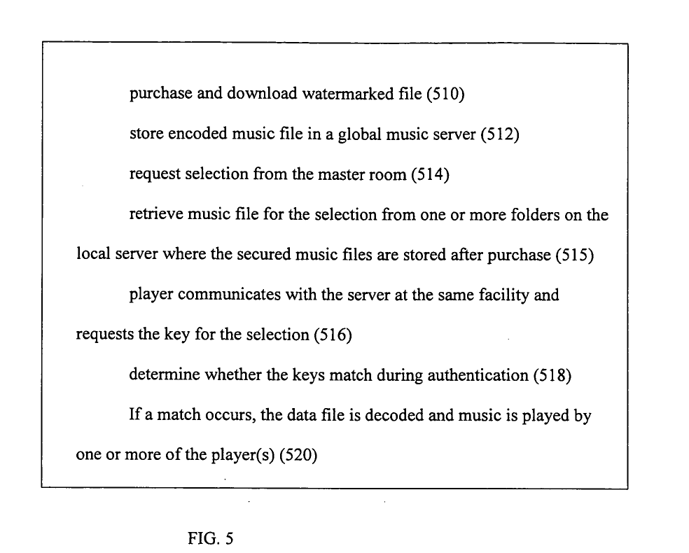

FIG. 5 shows one embodiment of a simplified flow diagram of a process for buying and distributing secured music. In this process, a system at the global server utilizes the digital watermark process to embed a unique identification corresponding to a user purchase information into copyrighted music track. A system remote from the global server scans music files and extracts the unique identification from the music file to determine the original purchaser of the file. The use of the system is for determining the source of files traded on the Internet so that the rights holder of the copyrighted or trademarked file can pursue copyright or trademark violations against the original purchaser. This system could also apply to all other digital file types.

Referring now to FIG. 5, first, a user purchases and downloads a watermarked file (510). Next, the process stores the encoded music file in a global music server (512). The user requests a selection from the master room (514). The music file for the selection is then retrieved from one or more folders on the local server where the secured music files are stored after purchase (515). The player communicates with the server at the same facility and requests the key for the selection (516). Next, the process determines whether the keys match during authentication (518). If a match occurs, the data file is decoded and music is played by one or more of the player(s) (520). The authentication can simply be a comparison of the key value stored in the watermarking and the key value stored at the local server or the key value typed in by the user to unlock the music file. If the values math, the downloaded file is authenticated. In another embodiment that provides for dynamic key values, the key value in the watermarking and the key value provided by the user are hashed in accordance with a formula. If both hashed values match, then the file is authenticated.

It is to be understood that various terms employed in the description herein are interchangeable. Accordingly, the above description of the invention is illustrative and not limiting. Further modifications will be apparent to one of ordinary skill in the art in light of this disclosure. Thus, although primarily intended to be used in audio-visual environment such as portable network music player, this invention is also applicable in any multimedia environment. Examples of such environment include but are not limited to software and games delivery systems, digital books and collaborative creation of documents. Moreover, although the invention has been discussed with reference to MP3, a variety of different audiovisual coding standards, including DVD, MPEG, DVB, AC3, Ogg, Vorbis, Theora, SLP, RTSP, MODPCM, DSD, FLAC, MPEG-1, MPEG-2, MPEG-4, MPEG-7, H.261, and H.263, can be used as well.

The invention has been described in terms of specific examples which are illustrative only and are not to be construed as limiting. For example, the portal can additionally support services that are transaction driven. Once such service is advertising: each time the user accesses the portal, the client workstation downloads information from the server 20. The information can contain commercial messages/links or can contain downloadable software. Based on data collected on users, advertisers may selectively broadcast messages to users. Additionally, the portal offers contents and forums providing focused articles, valuable insights, questions and answers, and value-added information about related music issues.

The invention may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

While the preferred forms of the invention have been shown in the drawings and described herein, the invention should not be construed as limited to the specific forms shown and described since variations of the preferred forms will be apparent to those skilled in the art. Thus the scope of the invention is defined by the following claims and their equivalents.

What is claimed is:

1. A method to distribute music, comprising:
embedding ownership information in a music file;
detecting unauthorized sharing of the music file; and
determining an owner of the shared music file by decoding the embedded ownership information from the music file.

2. The method of claim 1, wherein the embedding ownership information comprises watermarking the ownership information.

3. The method of claim 3, wherein the watermarking comprises audio-watermarking the ownership information.

4. The method of claim 1, comprising allowing the owner to download the music file through a local area network.

5. The method of claim 6, wherein the local area network is wired or wireless.

6. The method of claim 1, wherein the unauthorized sharing comprises storing the music file on a file-sharing system.

7. The method of claim 1, comprising sending the ownership information of the shared music file for copyright enforcement.

8. A system to distribute music, comprising:
means for embedding ownership information in a music file;
means for detecting unauthorized sharing of the music file; and
means for determining an owner of the shared music file by decoding the embedded ownership information from the music file.

9. The system of claim 8, wherein the means for embedding ownership information watermarks the ownership information.

10. The system of claim 9, wherein the watermark comprises an audio-watermark for the ownership information.

11. The system of claim 8, comprising means for allowing the owner to download the music file through a local area network.

12. The system of claim 11, wherein the local area network is wired or wireless.

13. A system to support secure music distribution, comprising:
a communication network in a facility;
a server coupled to the network, the server adapted to store one or more music files encoded with ownership information;
a player coupled to the network, the player adapted to play the music files; and
a copyright protection device coupled to the server, the device detecting unauthorized sharing of the music file and determining an owner of the shared music file by decoding the embedded ownership information from the music file.

14. The system of claim 13, wherein the ownership information is encoded as a watermark.

15. The system of claim 14, wherein the watermark comprises an audio-watermark embedded in the music file.

16. The system of claim 13, comprising means for allowing the owner to download the music file through a local area network.

17. The system of claim 16, wherein the local area network is wired or wireless.

18. The system of claim 13, wherein music is not played if the ownership information is not authenticated.

19. The system of claim 13, comprising a file sharing detector adapted to retrieve music files stored on a file sharing network and decode the watermark to determine ownership.

20. The system of claim 19, wherein the file sharing detector notifies a copyright owner based if the music file is shared.
